(19) United States
(12) Patent Application Publication
(10) Pub. No.: US 2002/0185462 A1
(43) Pub. Date: Dec. 12, 2002

(54) Syerling brown

(76) Inventor: Sterling Brown, Bronx, NY (US)

Correspondence Address: Matthew J. Peirce, Esq., 1550 Starlight Canyon Avenue, Las Vegas, NV, 89123, US

(21) Appl. No.: 10/165,584

(22) Filed: Jun. 8, 2002

Related U.S. Application Data
(60) Provisional application No. 60/296,520, filed on Jun. 8, 2001.

(51) Int. Cl. A23L 2/54

(52) U.S. Cl. 215/200; 215/228; 99/323.1

(57) ABSTRACT

A product for maintaining carbonation within liquids that originally have carbonation when they are purchased is disclosed. Such liquids would include soda, beer, champagne, carbonated water, and other liquids that are commonly bought with carbonation. Usually, after bottles containing these liquids are opened once or twice, the liquid tends to rapidly go flat and lose a lot of its taste. The present invention would help to prolong the number of times such a bottle could be opened and still have the liquid maintain the carbonation.

### I. BACKGROUND OF THE INVENTION

The present invention concerns that of a new and improved product for maintain carbonation within liquids that originally have carbonation when they are purchased.

### II. DESCRIPTION OF THE PRIOR ART

U.S. Pat. No. 5,823,372, issued to Levine, discloses a pump comprised of a resilient, hollow body, capable of being inserted between a cap and a bottle, used to re-carbonate a beverage.

U.S. Pat. No. 5,653,352 issued to Kim, discloses a resealable bottle with a pump incorporated for pressurizing the contents of said bottle.

U.S. Pat. No. 5,503,282, issued to Montgomery, discloses a two piece pressurizing closure comprised of a gas barrier sealing insert for a cap of a carbonated soft drink bottle.

### III. SUMMARY OF THE INVENTION

The present invention concerns that of a new and improved product for maintain carbonation within liquids that originally have carbonation when they are purchased. Such liquids would include soda, beer, champagne, carbonated water, and other liquids that are commonly bought with carbonation. Usually, after bottles containing these liquids are opened once or twice, the liquid tends to rapidly go flat and lose a lot of its taste. The present invention would help to prolong the number of times such a bottle could be opened and still have the liquid maintain the carbonation.

There has thus been outlined, rather broadly, the more important features of a carbonation maintenance product that the detailed description thereof that follows may be better understood and in order that the present contribution to the art may be better appreciated. There are, of course, additional features of the carbonation maintenance product that will be described hereinafter and which will form the subject matter of the claims appended hereto.

In this respect, before explaining at least one embodiment of the carbonation maintenance product in detail, it is to be understood that the carbonation maintenance product is not limited in its application to the details of construction and to the arrangements of the components set forth in the following description or illustrated in the drawings. The carbonation maintenance product is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present carbonation maintenance product. It is important, therefore, that the claims be regarded as including such equivalent constructions insofar as they do not depart from the spirit and scope of the present invention.

It is therefore an object of the present invention to provide a carbonation maintenance product which has all of the advantages of the prior art and none of the disadvantages.

It is another object of the present invention to provide a carbonation maintenance product which may be easily and efficiently manufactured and marketed.

It is another object of the present invention to provide a carbonation maintenance product which is of durable and reliable construction.

It is yet another object of the present invention to provide a carbonation maintenance product which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention.

FIG. 2 shows a perspective view of an alternative embodiment of the present invention.

### V. DESCRIPTION OF THE PREFERRED EMBODIMENT

Priority is hereby claimed to application Ser. No. 60/296,520, filed on Jun. 08, 2001.

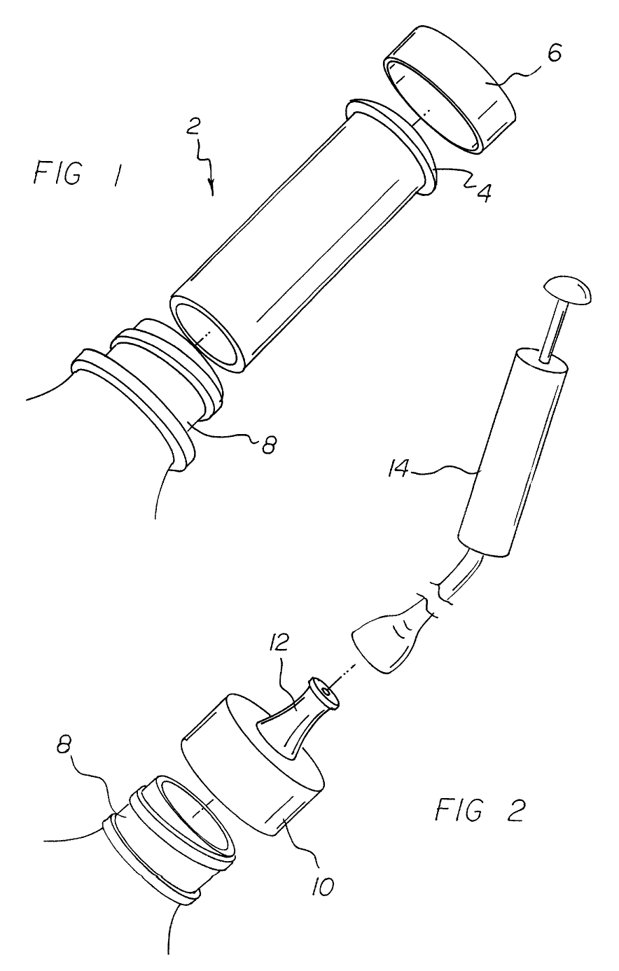

FIG. 1 shows a perspective view of the present invention. Cylindrical insert 2 would have two ends, a first end and a second end. The first end would be slightly smaller in diameter than that of an opening for a container containing carbonated liquid. The first end could either be open or closed. When insert 4 would be inserted into bottle 8, air would not be able to escape around the sides of insert 4, or would only be able to escape very slowly.

The second end of insert 2 would have soft disk 4 attached to it. Disk 4 would be formed of a pliable substance and would have a diameter slightly greater than that of the insert 2. Disk 4 would have two sides, a first side and a second side, with the first side of disk 4 being attached to the second end of insert 2. The second side of disk 4 would be slightly rounded, causing disk 4 to have a slight resemblance to that of a mushroom cap on a mushroom. Disk 4 would replace the soft air sealant insert that is usually present in the inside of bottle caps.

Bottle cap 6 would be placed over disk 4 once insert 2 had been substantially placed within a bottle 8. Disk 4 would be wider than the mouth of bottle 8, allowing disk 4 to be the only portion of insert 2 to remain outside a bottle. Once bottle cap 6 would be placed over disk 4 and tightly screwed onto bottle 8, disk 4 would mold itself into the inside shape of bottle cap 6, completely preventing air from escaping within bottle 8.

FIG. 2 shows a perspective view of an alternative embodiment of the present invention. In this embodiment, bottle cap 10 would include air pump nozzle 12 which would be fixedly attached to the top of bottle cap 10. After bottle cap 10 had been tightly screwed onto bottle 8, an individual could attach a small air pump 14 to air pump nozzle 12, and pump one or two times to increase the air pressure within the bottle. The increased air pressure would insure that the liquid inside the bottle would stay carbonated for a longer period of time, and would also allow the bottle cap 10 to be removed many more times, with the carbonation staying within the liquid as long as a user would routinely pump air into bottle 8 through air pump nozzle 12. Care would have to be taken, however, to insure that too much air was not pumped in through air pump nozzle 12, lest the bottle 8 explode.

What I claim as my invention is:

1. A carbonation maintenance apparatus in combination with a container, the container comprising a cylindrical opening, the carbonation maintenance apparatus comprising:
(a) a cylindrical insert having two ends, a first end and a second end, the first end being slightly smaller in diameter than that of the cylindrical opening for the container, the first end being either open or closed,
(b) a soft disk having two sides, a first side and a second side, the first side of the soft disk being attached to the second end of the cylindrical insert, the disk having a diameter slightly greater than that of the cylindrical insert, the soft disk being fabricated from a pliable substance, the second side of the soft disk being slightly rounded,
(c) a volume of carbonated liquid located within the container,
(d) a screw-on bottle cap,
(e) wherein a user would insert the first end of the cylindrical insert into the cylindrical opening of the container until the soft disk would prevent further insertion, and further wherein a user would then threadably attach the screw-on bottle cap to the cylindrical opening.

2. A carbonation maintenance apparatus in combination with a container, the container comprising a cylindrical opening, the carbonation maintenance apparatus comprising:
(a) a screw-on bottle cap having two sides, a top side and a bottom side,
(b) an air pump nozzle attached to the top side of the screw-on bottle cap,
(c) a small air pump,
(d) a volume of carbonated liquid located within the container,
(e) wherein a user would threadably attach the screw-on bottle cap to the cylindrical opening, and further where in a user would attached the small air pump to the air pump nozzle and pump the small air pump at least one time to insert additional air into the container, and further wherein a user would then detach the small air pump from the air pump nozzle.
